(19) United States
(12) Patent Application Publication
(10) Pub. No.: US 2009/0109179 A1
(43) Pub. Date: Apr. 30, 2009

(54) HAND-HELD ELECTRONIC DEVICE

(75) Inventor: Cheng-Chi Cheng, Taoyuan City (TW)

Correspondence Address: STEVENS & SHOWALTER LLP, 7019 CORPORATE WAY, DAYTON, OH, 45459-4238, US

(73) Assignee: MOBINNOVA HONG KONG LIMITED, Wanchai (HK)

(21) Appl. No.: 11/962,648

(22) Filed: Dec. 21, 2007

(30) Foreign Application Priority Data
Oct. 24, 2007 (TW) 096217844

(51) Int. Cl. G06F 3/02; G09G 5/00

(52) U.S. Cl. 345/168

(57) ABSTRACT

A hand-held electronic device includes a main body and a keyboard. The keyboard has a plurality of keys and is disposed on the main body. A pressing portion is constructed on the top portion of each key, and the keys are arranged into a plurality of columns and a plurality of rows. A height difference exists between the pressing portions in two adjacent rows, and every pressing portion in one row is staggered with two adjacent pressing portions in the other row, such that the distance between the keys in the two adjacent rows is the longest, thereby preventing a user from mistakenly pressing the keys when using the hand-held electronic device.

### CROSS-REFERENCE TO RELATED APPLICATIONS

This non-provisional application claims priority under 35 U.S.C. §119(a) on Patent Application No(s). 096217844 filed in Taiwan, R.O.C. on Oct. 24, 2007, the entire contents of which are hereby incorporated by reference.

### BACKGROUND OF THE INVENTION

1. Field of Invention

The present invention relates to a hand-held electronic device. More particularly, the present invention relates to a hand-held electronic device having a plurality of keys.

2. Related Art

Recently, the most popular business hand-held electronic device is definitely Blackberry manufactured by Research In Motion Ltd. (RIM). Business people can use Blackberry to fulfill various mobile business functions, such as to receive and send e-mails, surf the network, and carry out real-time communication at any time. Therefore, it is necessary for the Blackberry to be provided with a QWERTY keyboard, which is constituted by a plurality of keys like those on a computer keyboard serving as input media of the preset functions of the Blackberry, and it is easy for users to get familiar with the arrangement of the keys.

Recently, business mobile phones such as Blackberry are gradually miniaturized to improve the using convenience. Thus, the volume of the hand-held business mobile phone becomes increasingly lighter and thinner, and the size of the keyboard disposed thereon has to be reduced. However, as the QWERTY keyboard employs a large number of keys, and meanwhile a display screen and the keyboard are both disposed on the operating panel of the business mobile phone, the business mobile phone has to be large enough to accommodate these keys. In this manner, the business mobile phone emphasizing portability may well lose its advantage. If the size of the keyboard is reduced in order to achieve the miniaturization of the business mobile phone, a user may mistakenly press the keys, or find it difficult to recognize the labels on the keys, which will result in misoperations. Thereby, it is not convenient for the user to press keys of an excessively small size.

In order to solve the above problem, a hand-held electronic device is provided in Taiwan Patent No. M294676. The height of each key changes according to its distance from the center point of the electronic device, and the nearer a key from the center point is, the higher the key protruding from the main body will be. As such the keys are arranged in an arc on the main body, and it is convenient for the user to identify each key.

In the Patent No. M294676, the keys are distinguished from each other through the change of the protruding height. However, on the whole, the highest position and the lowest position formed by the keys are respectively located on the center and the edge of the electronic device, the change of the height between two adjacent keys is not distinct, and the distance between two keys is too short. Therefore, when a user intends to press one of the keys, it is easy to cause misoperation by mistakenly pressing the adjacent keys.

In addition, in U.S. Pat. No. 7,073,964, the keys of the hand-held electronic device are staggered on the main body, so as to reduce the space occupied by the plurality of keys, and to achieve the purpose of miniaturizing the electronic device. Further, a hand-held electronic device is disclosed in U.S. Pat. No. 7,113,111, in which a plurality of rows constituted by keys are arranged on the main body at an angle of 30-50° to a center line of the electronic device, so as to reduce the space occupied by the keys and to facilitate a user identifying each key.

For the aforementioned U.S. Pat. No. 7,073,964 and No. 7,113,111, the keys are staggered or arranged in an angle, so as to extend the distance between every two keys. However, as the height difference between two keys is not distinct, the user may mistakenly press the adjacent keys when using the hand-held electronic device.

### SUMMARY OF THE INVENTION

In view of the above problems, the present invention provides a hand-held electronic device, to solve the problem in the conventional hand-held electronic device that, the user may mistakenly press the adjacent keys in operation.

The hand-held electronic device of the present invention includes a main body, a display screen, and a keyboard. The display screen and the keyboard are disposed on the main body, the keyboard has a plurality of keys, and a pressing portion is constructed on the top portion of each key. The plurality of keys are arranged from top to bottom into a plurality of rows, and from left to right into a plurality of columns. A height difference exists between the pressing portions in two adjacent rows, and every pressing portion in one row is staggered with two adjacent pressing portions in the other row.

The advantage of the present invention is that, as a height difference exists between the keys in two adjacent rows and the keys in the two adjacent rows are staggered with each other, the center point of each key in the two adjacent rows is not on the same straight line, and the distance between two adjacent keys is the longest, thereby preventing the user from mistakenly pressing the keys when using the hand-held electronic device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a front view of a first embodiment of the present invention;

FIG. 2 is a right view of the first embodiment of the present invention;

FIG. 3 is a bottom view of the first embodiment of the present invention;

FIG. 4 is a front view of a second embodiment of the present invention; and

FIG. 5 is a right view of different forms of keys of the present invention.

### DETAILED DESCRIPTION OF THE INVENTION

The hand-held electronic device of the present invention which likes a mobile phone, a personal digital assistant (PDA), a notebook computer, a flat panel computer, but not limit to the above-mentioned portable electronic devices. In the following detailed description of the present invention, PDA is taken as the most preferred embodiment of the present invention. In addition, the accompanying drawings are only for reference and illustration, instead of limiting the present invention.

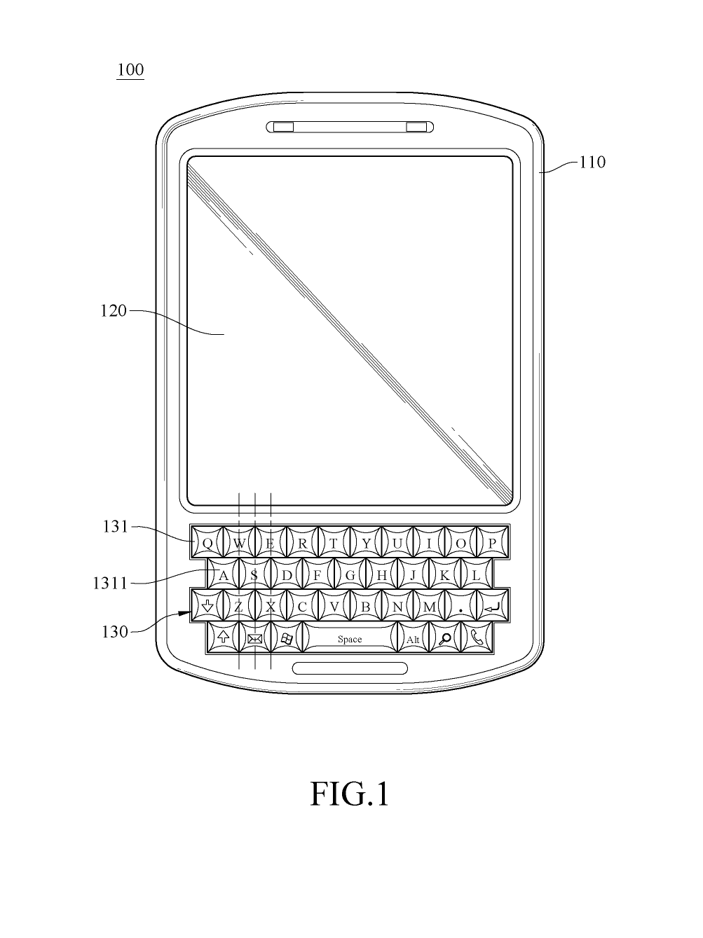

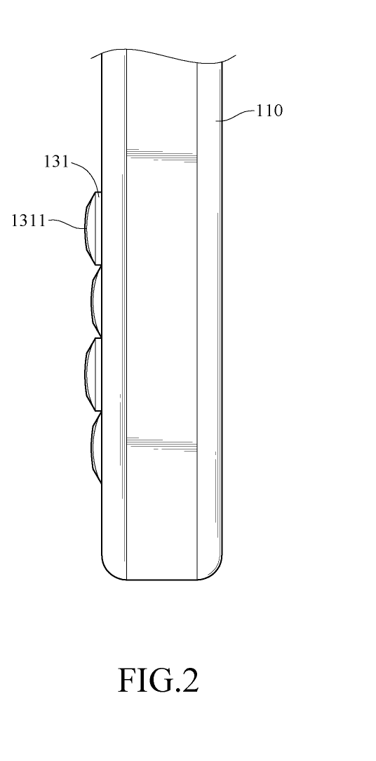

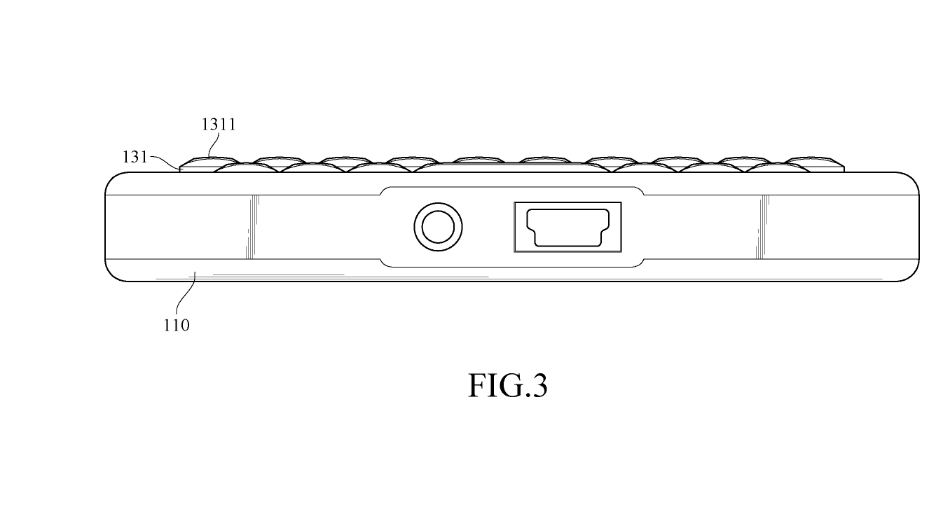

FIGS. 1 to 3 are schematic views of a first embodiment of the present invention. The hand-held electronic device 100 of the present invention includes a main body 110, a display screen 120, and a keyboard 130. A circuit board and electronic elements for executing operation (not shown) are disposed in the main body 110, so as to perform the preset functions of the electronic device 100. The display screen 120 is disposed on the main body 110, and is electrically connected to the circuit board, to display images, texts, and other relative information of the electronic device 100. The present invention is not directed to the circuit layout in the main body and the technique of the display screen, which are familiar to those skilled in the art, and will not be described in detail herein again.

The keyboard 130 is disposed on the main body 110, and close to the display screen 120. The keyboard 130 is a QWERTY keyboard having a plurality of keys 131, and a pressing portion 1311 is constructed on the top portion of each key 131. The plurality of keys 131 is arranged from top to bottom into a plurality of rows, and from left to right into a plurality of columns, and the keys 131 abut each other. The first row is sequentially arranged as Q, W, E, R, T, Y, U, I, O, P, the second row is sequentially arranged as A, S, D, F, G, H, J, K, L, and the third row is sequentially arranged as Z, X, C, V, B, N, M, thus constituting a QWERTY keyboard layout.

Please refer to FIGS. 1 to 3, for this embodiment, keys “W” and “E” in the first row and key “S” in the second row are taken as an example, to give a more detailed description of the characteristics of the present invention. The following illustration is suitable for the relative relation of each key in any two adjacent rows, and it is not limited herein.

The height of each pressing portion 1311 of the keys “W” 131 and “E” 131 in the first row is higher than the pressing portion 1311 of the key “S” 131 in the second row, such that a height difference exists between the pressing portions 1311 of the keys 131 in first row and the pressing portion 1311 of the key 131 in the second row. Besides, the position of the key “S” 131 is located between the key “W” 131 and the key “E” 131, and thus the keys 131 in the first and second rows are staggered with each other. As the pressing point of each pressing portion 1311 in the two adjacent rows is not on the same vertical reference line, and a height difference exists between the pressing portions 1311 in the two adjacent rows, the three-dimensional (3D) distance between the keys “W” 131 and “E” 131 in the first row and the key “S” 131 in the second row is increased, thereby preventing the user from mistakenly pressing the adjacent keys 131.

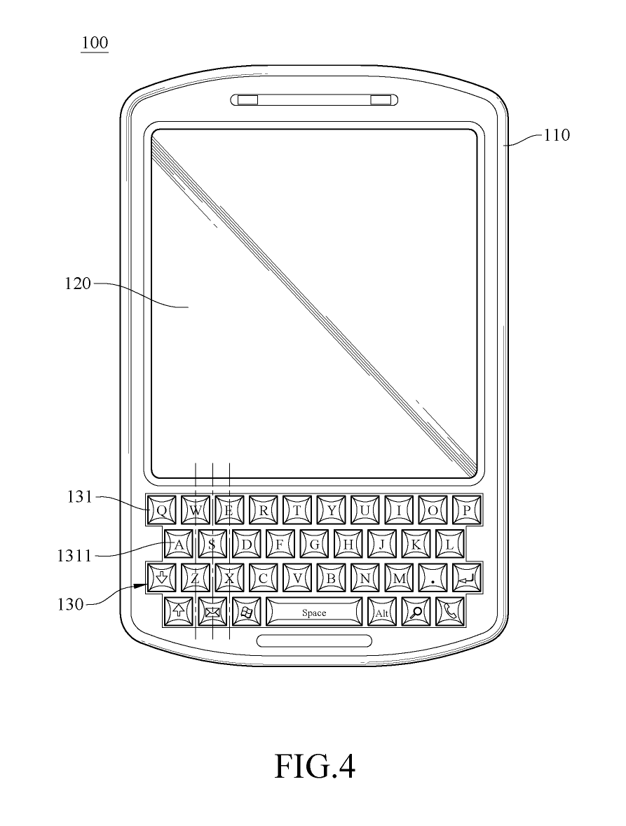

FIG. 4 is a schematic view of a second embodiment of the present invention. On the keyboard 130 of the second embodiment, the keys 131, spaced from each other by a certain distance, are arranged from top to bottom of the main body 110 into a plurality of rows, and from left to right into a plurality of columns, thus constituting a QWERTY keyboard layout. The distance between each key 131 of the second embodiment of the present invention is larger than that of the first embodiment, such that it is less likely that the user may mistakenly press the adjacent keys 131 when using the hand-held electronic device 100.

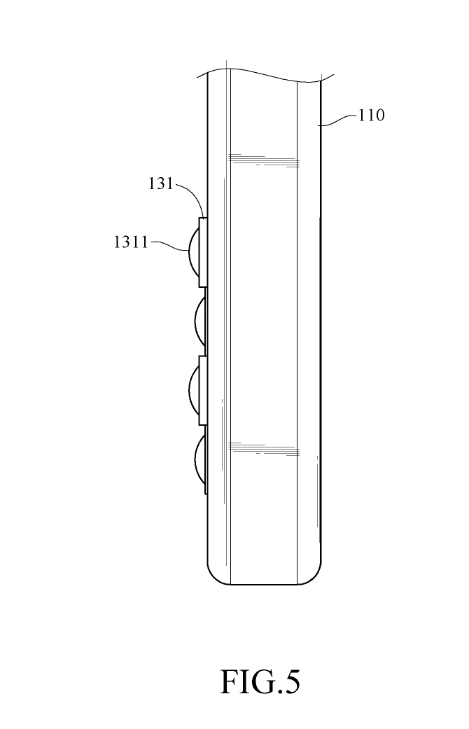

FIG. 5 is a side view of different forms of keys of the present invention. In addition to the form of the keys 131 in the second embodiment of the present invention, those skilled in the art can modify the pressing portion 1311 of each key 131 into another form, such as dome, column, cube, or other geometric shapes, which is not limited to the embodiment of the present invention.

For the hand-held electronic device of the present invention, a height difference exists between the keys in two adjacent rows, and the keys in the two adjacent rows are staggered with each other, such that the 3D distance between the keys in the two adjacent rows is the longest, thereby preventing the user from mistakenly pressing the keys when using the hand-held electronic device, and greatly enhancing the convenience of using the hand-held electronic device.

Moreover, as the keys are staggered with each other, the volume of the keyboard can be reduced, so as to achieve the purpose of miniaturizing the hand-held electronic device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hand-held electronic device, comprising:
a main body;
a display screen, disposed on the main body; and
a keyboard, disposed on the main body, wherein the keyboard has a plurality of keys and a pressing portion is disposed on the top portion of each key; the keys are arranged from top to bottom into a plurality of rows, and from left to right into a plurality of columns; a height difference exists between the pressing portions in two adjacent rows, and every pressing portion in one row is staggered with two adjacent pressing portions in the other row.

2. The hand-held electronic device as claimed in claim 1, wherein the keys abut each other, and are disposed on the main body.

3. The hand-held electronic device as claimed in claim 1, wherein the keys are spaced by a distance, and are disposed on the main body.

4. The hand-held electronic device as claimed in claim 1, wherein the keyboard is a QWERTY keyboard.
